(19) United States
(12) Patent Application Publication
(10) Pub. No.: US 2021/0156120 A1
(43) Pub. Date: May 27, 2021

(54) SYSTEM FOR DETECTING UNCRUSHABLE MATERIALS FOR INSTALLATION IN HEAVY MACHINERY BUCKETS

(71) Applicant: Alejandro HIDALGO CARRASCO, Comuna de Huechuraba Santiago (CL)

(72) Inventor: Alejandro HIDALGO CARRASCO, Comuna de Huechuraba Santiago (CL)

(21) Appl. No.: 17/058,248

(22) PCT Filed: May 29, 2019
(86) PCT No.: PCT/CL2019/000022

§ 371 Date: Nov. 24, 2020

(30) Foreign Application Priority Data
May 29, 2018 (CL) 1433-2018

(51) Int. Cl. E02F 9/26; G01S 13/04; G01S 13/88; B60Q 5/00; B60K 35/00; G07C 5/00

(52) U.S. Cl. CPC E02F 9/26; G01S 13/04; G01S 13/886; G01S 13/89; B60K 35/00; G07C 5/008; B60Q 5/005

(57) ABSTRACT

A System for detecting uncrushable material is provided which has one or more transducers arranged in the buckets of heavy machinery, which connect to a CPU that stimulates them and connects them to buzzers that warn when uncrushable material is detected.

The present application is to implement an innovative system for detecting uncrushables that load ores into heavy machinery: mining mechanical shovels; front loaders; others.

This load goes to the trucks that transport the ore to the primary crusher located in the same mine work.

The uncrushable are solid, generally metallic materials that are mixed with the ore being loaded, to be subsequently taken to the primary crushers. If the uncrushable reaches the primary crusher it can produce different temporary mechanical problems that can mean the work stoppage, with the consequent economic cost of repair.

The field of application of this new technique is all those ore processing companies that intend to eliminate an initial problem that consists in the elimination of these uncrushables, because as will be described later, they produce jams in the primary crushers that force to temporarily stop the work.

The proposed system aims to globally address the losses produced in the mining of different metals, by concepts of presence of uncrushables in their mining works. Losses estimated solely for the item uncrushables are estimated at USD 500 million. The information provided by a mining company indicates that the cost produced by these events would have been USD 6,025 million in one year and the cost of only one point event is USD 2 million.

The system contemplates the insertion of sensors in mining mechanical shovels and/or buckets of the front loaders, a system totally different from that currently used, according to the subsequent description.

### State of the Art

At present there is no effective method of detecting the uncrushables that are transferred to the primary crushers.

The current methods used are: TAG—GET and Motions Metric.

The problem is that with any of the methods used, the equal uncrushable is loaded to the truck that feeds the primary crusher. When an uncrushable is detected in the loading, it is not known in which of the trucks it was loaded and per protocol, most of the mining companies dispose the load of the last three trucks of the circuit, with the consequent loss by the disposed ore. If the uncrushable was not in the disposal, it also reaches the primary crusher causing damages of different nature and high maintenance, repair and/or replacement costs as the case may be.

Consequently, the company loses due to the disposed ore of three trucks and/or the maintenance, repair or replacement of the damaged primary crusher.

The Tag—Get method consists of attaching a sensor to each of the nine teeth of the bucket that are part of the mechanical shovel. The sensor is located at the base of each tooth. When the loss of any tooth occurs, an alarm is activated and the operator perceives the loss, causing the existence of an uncrushable, and the following situations may occur:
a) One or more of the nine teeth is fractionated, falling into the bucket and the tooth are transported to the primary crusher, in this case the alarm does not sound because a section not covered by the sensor has been fractionated.
b) By friction of the bucket collecting ore, the sensor acquires temperature and can activate the alarm which can be false, because the tooth has not fallen, generating doubts to the operator; or the alarm may not be activated, even if the tooth is loaded to the truck, reaching the crusher.

The percentage of non-detection is estimated at approximately 25%.

The Motion Metric camera system, consists of the operator located at height, uses a strategic camera that points to the bucket only in the area of the teeth, and an alarm warns of the loss of some of them in 2D image. The percentage of non-detection is estimated at approximately 20%.

The industrial patent registration proposal differs from the current methods, due to the elimination of sensors on the teeth of the bucket or the Motions Metric camera, depending on the method used. The change consists of placing one or two sensors attached on the rear of the bucket, so as to cover 100% of the volume of ores loaded in it, and be able to detect the existence of an uncrushable. Virtual simulations of the invention demonstrate that the proposal is 95% effective regarding the prior art.

Two types of advantages of the invention proposal are presented. The first relates to the simplification of the detection system regarding the two methods used. In the first case, the placement of sensors in 9 teeth of the bucket having an error percentage of 25% is eliminated. In the second case, the use of a two-dimensional camera is also eliminated, which does not fully cover the visual area under control, which has an error margin of 20%. The proposal only uses one or two sensors attached on the rear of the bucket.

The second advantage is of an economic nature, because the cost of disposal ore and/or the maintenance, repair and/or replacement of the damaged crusher is eliminated.

Information received from a mining company indicates that only for the cost of crushers damaged by uncrushables, U.S. Pat. No. 6,025,000 would have been spent in one year.

### BRIEF DESCRIPTION OF THE DRAWINGS

FIG. 1: Represents a complete view of the system of detection of uncrushables via high frequency waves, which will be installed in the different models of heavy machinery, both for loading ores or aggregates in general.

FIG. 2: Represents a view of the prototype of integral bucket with a mining shovel or front loaders, with one or more sensors incorporated.

FIG. 3: Represents a view of the sensor (Transducer) to be adhered to the mechanical blade, which is part of the device of the present invention.

FIG. 4: Represents a view of the special CPU that, when connected to the electric current, allows programming of the uncrushable detection process, which is part of the device of the present invention.

FIG. 5: Represents a view of the buzzer or alarm connected to the CPU that stimulates the sensor and allows the operator of the machine to be warned of the presence of uncrushables.

FIG. 6: Represents a view of the monitor with software with 3D image interpretation. FIG. 7: Represents a view of the computer that is remotely connected to the system that is operating on the heavy machinery.

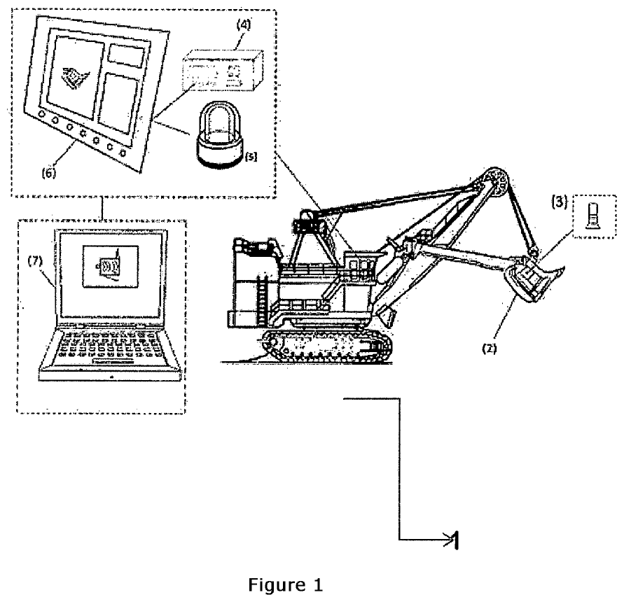

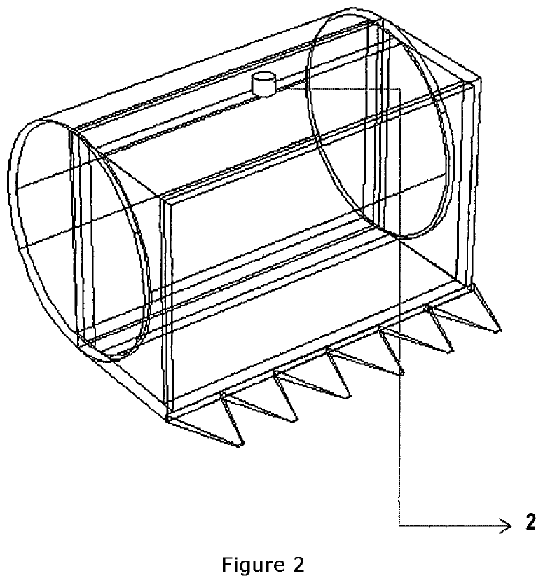

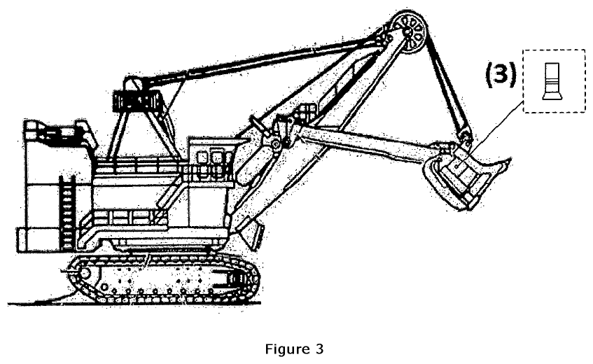

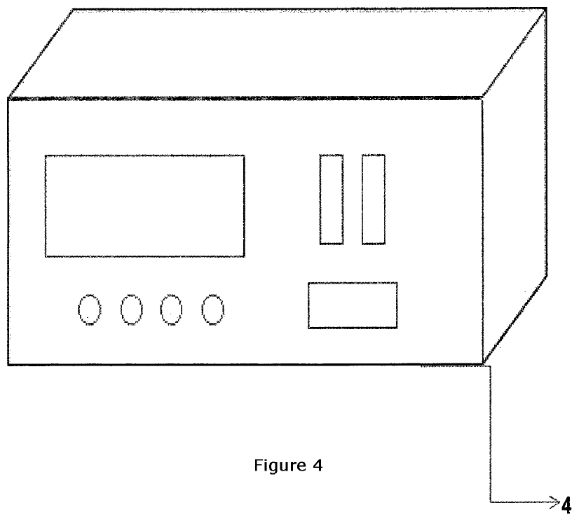

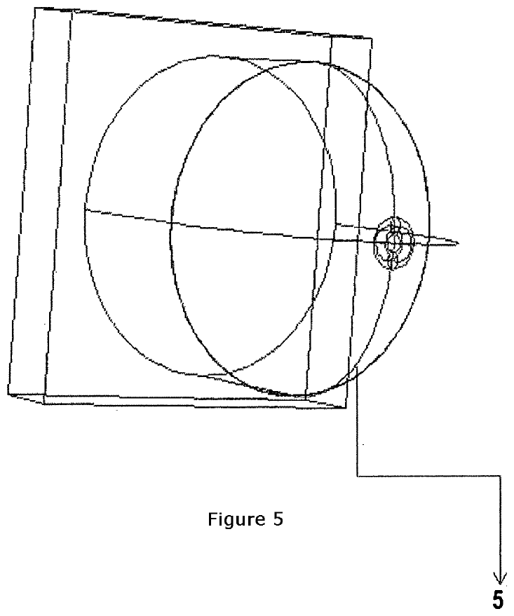

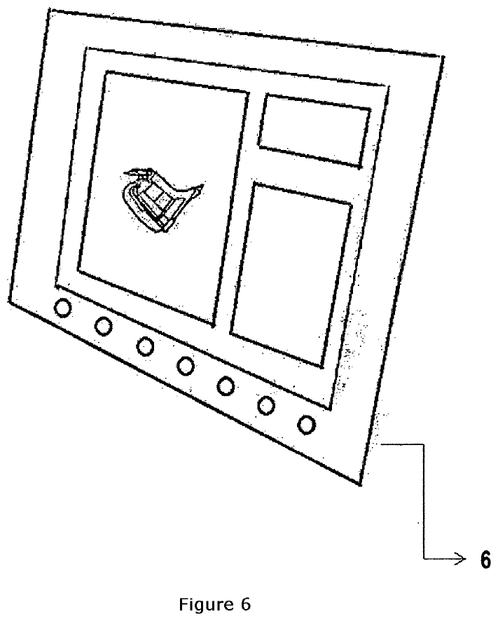

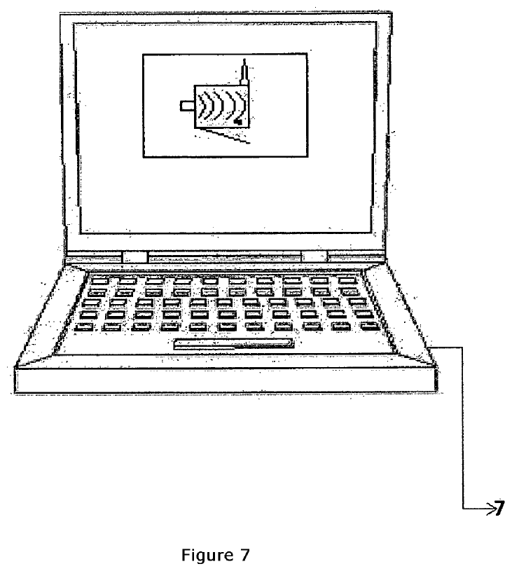

### DETAILED DESCRIPTION OF THE INVENTION

The invention consists of a system composed of different components whose ultimate objective is to detect uncrushables in the loadings of buckets of heavy mining machinery, with accuracy greater than 90% with respect to the two methods currently used by the mining industry.

The system comprises the use of transducing sensors placed in the buckets, which connected to a CPU, activate alarms, which in turn, inform a control room.

The invention decreases operating costs for items of ore losses and/or repair or replacement of equipment of crushers, damaged by uncrushables not detected opportunely.

The detail of the operation is as follows: the system (1) comprises the composition of different elements such as: sensors that are installed indistinctly in buckets of mechanical blades or front loaders (2). The innovation proposal is the placement of transducing sensors (3) on the outer wall of the buckets (2). These transducing sensors (3) make it possible to detect stocks of uncrushables in the total volume of the load contained in the buckets (2). In this way, the contaminated load does not reach the truck and has an effectiveness of 95% with respect to the two methods currently used to detect uncrushables.

The transducing sensor (3) constitutes the main device of the system, because it allows the premature detection of the existence of uncrushables. If this presence exists, a CPU (4) installed in the cabin of the heavy machinery, receives the signals emitted by the transducing sensors (3), activating the buzzer or alarm (5) that warns the operator through an internal monitor (6), to empty the contents of the buckets (2) with ore, on a stockpile area.

A computer (7) installed in the control room of the mining company, contains an interpreting software of the signals received by the CPU (4). This software is able to convert the received signals into 3D images, warning of the presence of uncrushables.

1. High-frequency wave system for installing in buckets of heavy machinery, which allows to detect the presence of uncrushables comprising: one or more transducers arranged in the buckets of the heavy machinery.

2. The high-frequency wave system for installing in buckets of heavy machinery, which allows to detect the presence of uncrushables, according to claim 1, wherein the one or more transducers are connected to a buzzer or alarm that is activated when the presence of uncrushables is detected.

3. The high-frequency wave system for installing in buckets of heavy machinery, which allows to detect the presence of uncrushables, according to claim 1, wherein a CPU can stimulate the one or more transducers installed in the bucket of heavy machinery.

4. The high-frequency wave system for installing in buckets of heavy machinery, which allows to detect the presence of uncrushables, according to claim 1, wherein a buzzer emits a sound warning the operator of the heavy machinery of the presence of an uncrushable in the buckets of heavy machinery, and in turn, records images in a monitor located inside a the cabin of the heavy machinery.

5. The high-frequency wave system for installing in buckets of heavy machinery, which allows to detect the presence of uncrushables, according to claim 1, wherein a computer in a control room records daily operations with or without load disposals.
